(19) United States
(12) Patent Application Publication
(10) Pub. No.: US 2014/0306925 A1
(43) Pub. Date: Oct. 16, 2014

(54) Sensing Method And Related Device For Touch Panel

(71) Applicant: NOVATEK Microelectronics Corp., Hsin-Chu (TW)

(72) Inventors: Yun-Hsiang Yeh, Hsinchu County (TW); Chih-Chang Lai, Taichung City (TW)

(73) Assignee: NOVATEK Microelectronics Corp., Hsin-Chu (TW)

(21) Appl. No.: 14/037,393

(22) Filed: Sep. 26, 2013

(30) Foreign Application Priority Data
Apr. 12, 2013 (TW) 102113131

(51) Int. Cl. G06F 3/044

(52) U.S. Cl. CPC G06F 3/044
USPC 345/174

(57) ABSTRACT

A sensing method for a touch panel is disclosed. The touch panel includes a plurality of sensing lines and a plurality of driving lines. The sensing method includes generating an electromagnetic signal or a capacitive signal; forming a plurality of first loops through the plurality of sensing lines to sense X coordinate of the electromagnetic signal on the touch panel and forming a plurality of second loops through the plurality of driving lines to sense Y coordinate of the electromagnetic signal on the touch panel when the electromagnetic signal is generated; sensing X coordinate of the capacitive signal through the plurality of sensing lines and sensing Y coordinate of the capacitive signal through the plurality of driving lines when the capacitive signal is generated.

### BACKGROUND OF THE INVENTION

1. Field of the Invention

The present invention relates to a sensing method and related device for a touch panel, and more particularly, to a method of integrating electromagnetic signal sensing and capacitive signal sensing on the touch panel and related device.

2. Description of the Prior Art

Since the technology has been evolving, there exist many types of input devices such as a keyboard, mouse, trackball, touch panel and etc., providing control on the electronic device for a user to execute programs or operations. The design trend for electronic devices is also towards small size, light-weight and all-in-one. However, the traditional input devices are not able to meet the user's demand and the electronic product does not have enough spaces for multiple input devices either.

A touch panel integrates functions of a mouse, a keyboard and a graphic tablet and also features in low-power consumption and compact appearance so more and more users choose the touch panel as an input device of their electronic devices. Through the touch panel the user can move the cursor or select the options on the screen, just by touching the touch panel with a finger and an optical pen. Thus, many of current electronic devices such as a personal digital assistant (PDA), a laptop and a mobile phone, global positioning system (GPS) are equipped with the touch panel as its input device.

Electromagnetic sensing technology employs a specific sensor board to receive electromagnetic signals from the electromagnetic pen. The analog electromagnetic signals received from the antenna are converted into digital signals by the certain circuit and the (X, Y) coordinates can be obtained by a coordinate transformation formula. If the electromagnetic sensing technology is applied to a TFT touch panel, the electromagnetic sensing circuit must be integrated below the liquid crystal display and above the cover of the liquid crystal display. Any substance blocking the electromagnetic signals is not allowed to exist in the atomic absorption (AA) area. This, however, requires modification on the current LCD module. Therefore, the design complexity and the thickness will be increased.

### SUMMARY OF THE INVENTION

It is therefore an objective of the present disclosure to provide a sensing method and related device for a touch panel.

A sensing method for a touch panel is disclosed. The touch panel comprises a plurality of sensing lines and a plurality of driving lines. The method comprises generating an electromagnetic signal or a capacitive signal on the touch panel; forming a plurality of first loops through the plurality of sensing lines to sense X coordinate of the electromagnetic signal on the touch panel and forming a plurality of second loops through the plurality of driving lines to sense Y coordinate of the electromagnet signal on the touch panel when the electromagnet signal is generated; and sensing X coordinate of the capacitive signal through the plurality of sensing lines and sensing Y coordinate of the capacitive signal through the plurality of driving lines when the capacitive signal is generated.

An integration circuit for a touch panel is disclosed. The touch panel comprises a plurality of sensing lines and a plurality of driving lines. The integration circuit comprises a control circuit, a switching unit, a plurality of multiplexer, an electromagnetic sensing unit and a capacitive sensing unit. The control circuit is used for controlling the plurality of sensing lines and the plurality of driving lines to sense a coordinate of an electromagnetic signal or a capacitive signal on the touch panel. The switching unit is coupled to the plurality of sensing lines and the plurality of driving lines, and used for controlling conduction among the plurality of sensing lines and conduction among the plurality of driving lines. The plurality of multiplexer are coupled to the plurality of sensing lines and plurality of driving lines, and used for controlling to the plurality of sensing lines and the plurality of driving lines to couple with different terminals. Each of the multiplexers is coupled to one of the sensing lines or one of the driving lines. The electromagnetic sensing unit is used for processing the coordinate of the electromagnet signal on the touch panel. The capacitive sensing unit is used for processing the coordinate of the capacitive signal on the touch panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary schematic diagram of a touch panel.

FIGS. 2 and 3 are schematic diagrams of exemplary sensing patterns.

FIG. 4 illustrates an exemplary loop formed by multiplexers through sensing lines.

FIG. 5 illustrates an exemplary loop formed by multiplexers and a switching unit through sensing lines.

FIG. 6 illustrates another exemplary loop formed by multiplexers and a switching unit through sensing lines.

FIG. 7 illustrates that a switching unit and multiplexers control sensing lines when sensing a capacitive signal according to an example of the present disclosure.

FIG. 8 is a schematic diagram of time-division multiplexing according to an example of the present disclosure.

FIG. 9 is a schematic diagram of integration of a controller, an electromagnet sensing unit and a capacitive sensing unit according to an example of the present disclosure.

FIG. 10 is a flow chart of an exemplary process.

### DETAILED DESCRIPTION

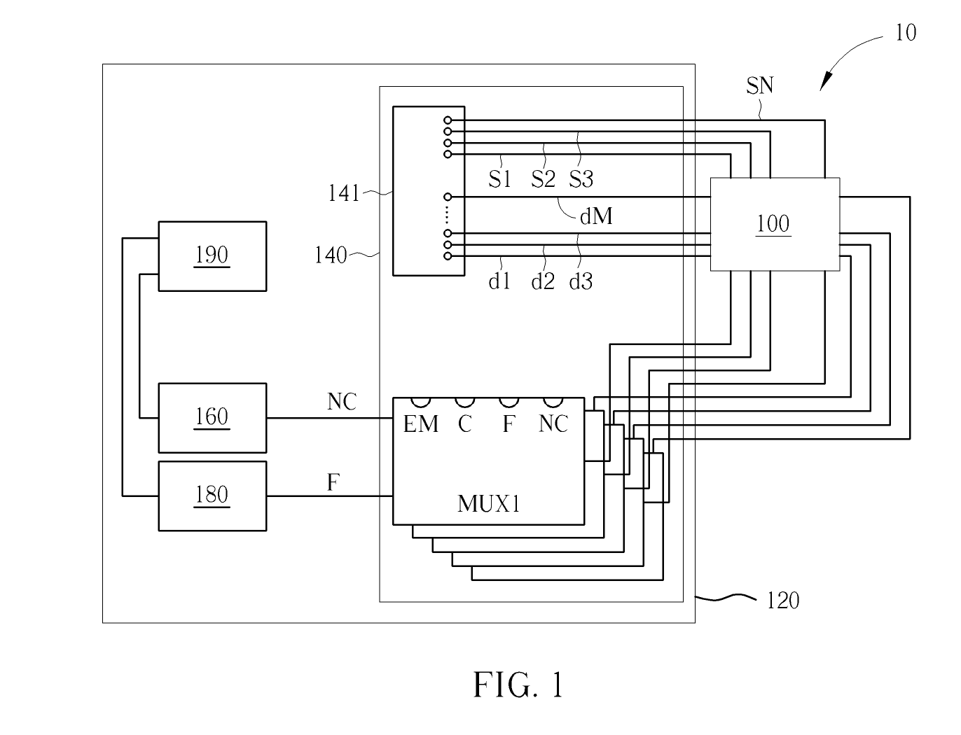

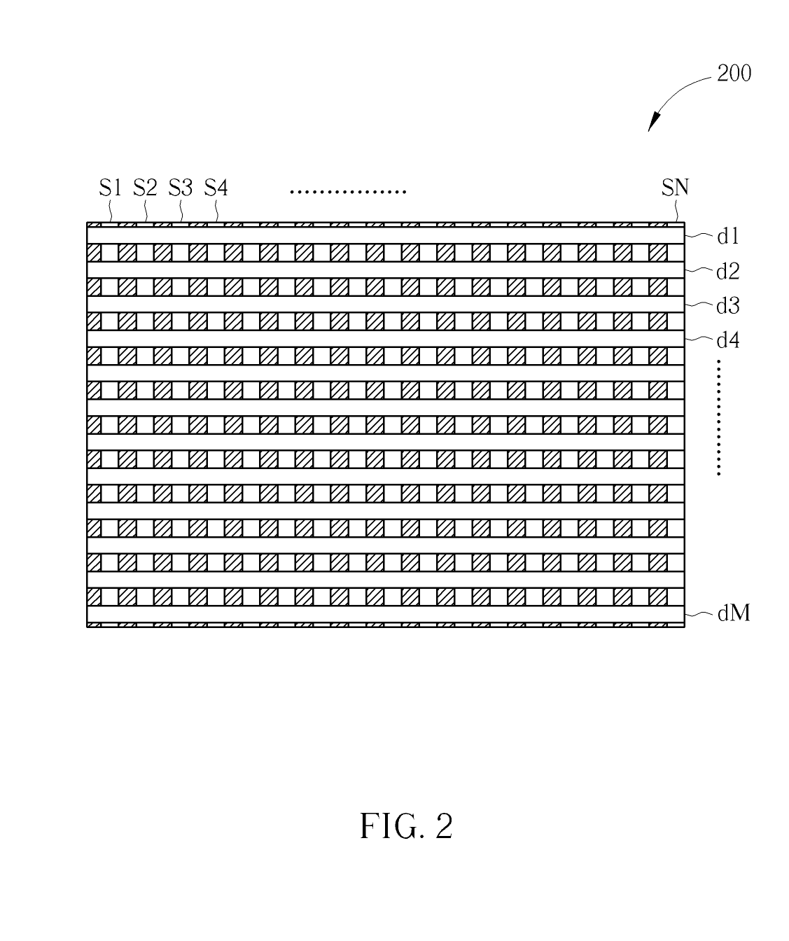

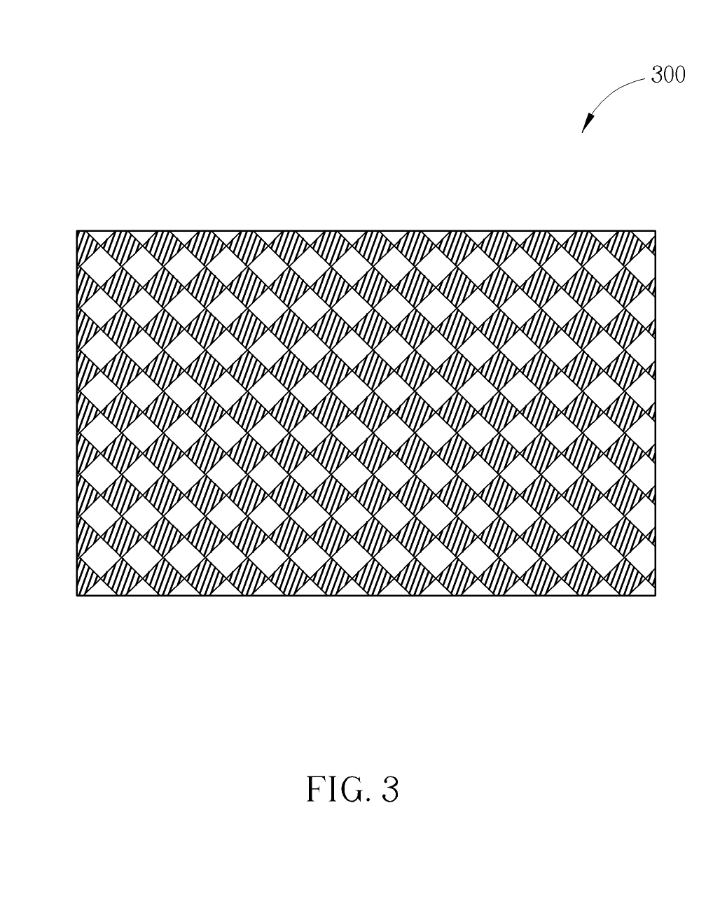

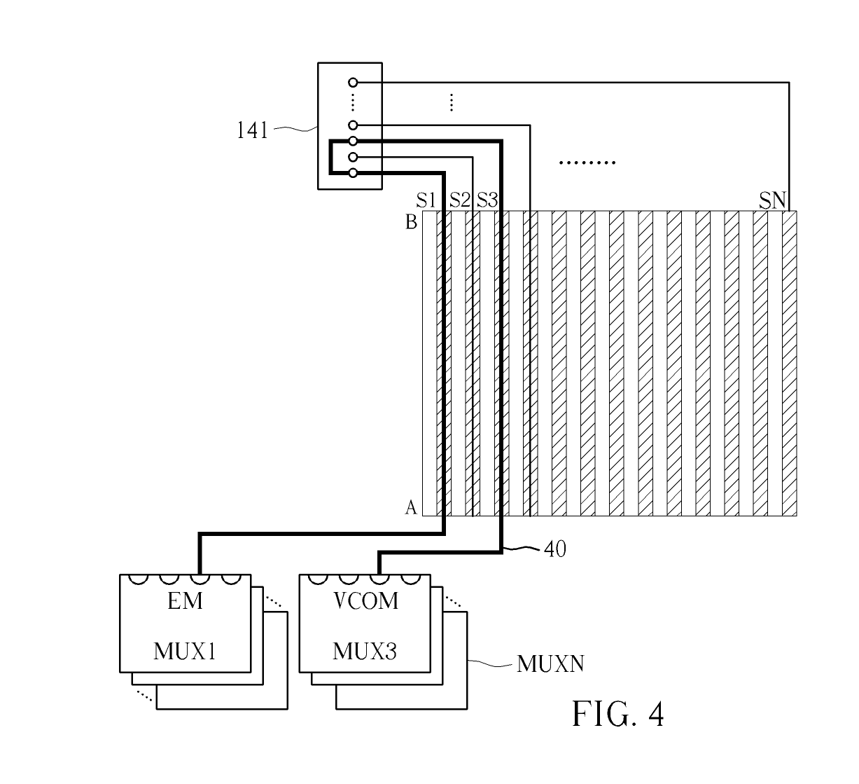

Please refer to FIG. 1, which is an exemplary schematic diagram of a touch panel 10. The touch panel 10 includes a sensor 100 and an integration circuit 120. The touch panel 10, preferably, is a capacitive touch panel or an Indium tin oxide (ITO) touch panel made of ITO. The sensor 100 includes multiple sensing lines S1, S2, S3, . . . , SN and multiple driving lines d1, d2, d3, . . . , dM. The sensor 100 is capable of sensing an electromagnetic signal SEM and a capacitive signal SC on the touch panel, generated by a user. Preferably, the sensor 100 is a capacitive sensor, which senses the X coordinate of the capacitor signal SC on the touch panel 10 through the sensing lines S1, S2, S3, . . . , SN and senses the Y coordinate of the capacitor signal SC on the touch panel 10 through the driving lines d1, d2, d3, . . . , dM. Please refer to FIGS. 2 and 3, which are schematic diagrams of a sensing pattern 200 and a sensing pattern 300 according to examples of the present disclosure. In the sensing pattern 200, the X coordinate consists of the sensing lines S1, S2, S3, . . . , SN and the Y coordinate consists of the driving lines d1, d2, d3, . . . , dM. In FIG. 3, the sensing pattern 300 is a variant of the sensing pattern 200 rotated by 45 degrees. The integration circuit 120 is coupled to the sensor 100 and includes a control circuit 140, an electromagnet sensing unit 160 and a capacitive sensing unit 180 and a controller 190. The electromagnetic sensing unit 160 is used for processing the coordinates of electromagnetic signal SEM on the touch panel 10. The control circuit 140 is coupled to the sensor 100 and used for controlling the sensing lines S1, S2, S3, . . . , SN and the driving lines d1, d2, d3, . . . , dM to sense the coordinates of the electromagnetic signal SEM or the capacitive signal SC on the touch panel 10. The control circuit 140 includes a switching unit 141 and multiple multiplexers MUX(1), MUX(2), . . . , MUX(N+M). The switching unit 141 is coupled to the sensing lines S1, S2, S3, . . . , SM and the driving lines d1, d2, d3, . . . , dM and used for controlling the conduction among the sensing lines S1, S2, S3, . . . , SM and the conduction among the driving lines d1, d2, d3, . . . , dM. The multiplexers MUX(1), MUX(2), . . . , MUX(N+M) are coupled to the electromagnet sensing unit 160, the capacitive sensing unit 180, switching unit 141, the sensing lines S1, S2, S3, . . . , SM and the driving lines d1, d2, d3, . . . , dM and the multiplexers MUX(1), MUX(2), . . . , MUX(N+M) are used for coupling the sensing lines S1, S2, S3, . . . , SM and the driving lines d1, d2, . . . , dM to different terminals. Each of the multiplexers MUX(1), MUX(2), . . . MUX(N+M) is coupled to one of the sensing lines S1, S2, S3, . . . , SM or one of the driving lines d1, d2, . . . , dM and it includes a common electrode VCOM (as shown in FIG. 4), an electromagnet sensing terminal EM, a capacitive sensing terminal C and a floating terminal F and a non-sensing terminal NC.

When a user generates the electromagnetic signal SEM on the touch panel (e.g. using an electromagnetic pen), the control circuit 140 forms the multiple first loops through the sensing lines S1, S2, S3, . . . , SN to sense the X coordinate of the electromagnetic signal SEM on the touch panel 10 and forms the multiple second loops through the driving lines d1, d2, d3, . . . , dM to sense the Y coordinate of the electromagnetic signal SEM on the touch panel 10. Please refer to FIG. 4, which illustrates a loop 40 formed by the multiplexers MUX(1), MUX(2), . . . , MUX(N) through the sensing line S1, S2, S3, . . . , SN. In FIG. 4, the switching unit 141 conducts the terminals B of the sensing lines S1 and S3. The multiplexer MUX (1) couples the terminal A of the sensing line S1 to the electromagnet terminal EM. The electromagnet terminal EM is further coupled to the electromagnetic sensing unit 160. Besides, the multiplexer MUX(3) couples the terminal A of the sensing line S3 to the common electrode VCOM, and keeps the terminals A of the other sensing lines floating. The touch panel 10 uses the switching unit 141 and the multiplexers MUX(1), MUX(2), . . . MUX(N) to control the conduction among the sensing lines S1, S2, S3, . . . , SN and couple the sensing lines S1, S2, S3, . . . , SN to the different terminals, in order to form the loop 40. Through the loop 40, the sensor 100 can sense the X coordinate of the electromagnetic signal SEM on the touch panel 10, thereby receiving and transmitting the electromagnetic signal SEM. Namely, each loop can be formed by conducting the terminals B of any two of the sensing lines and coupling the terminal A of one of that two sensing lines to the electromagnetic terminal EM and terminal A of the other sensing line to the common electrode VCOM. Likewise, each loop for the driving lines can be formed in this way. In this situation, the present disclosure can use a capacitive sensor to sense the electromagnetic signal without an extra electromagnetic sensor. In other words, the present discloses use the existing capacitive touch panel or ITO touch panel to sense the electromagnetic signal, thereby reducing the cost. In addition, it is not necessary for the present disclosure to integrate the electromagnet touch module below the liquid crystal display. Thus, the thickness of the liquid crystal display can be decreased.

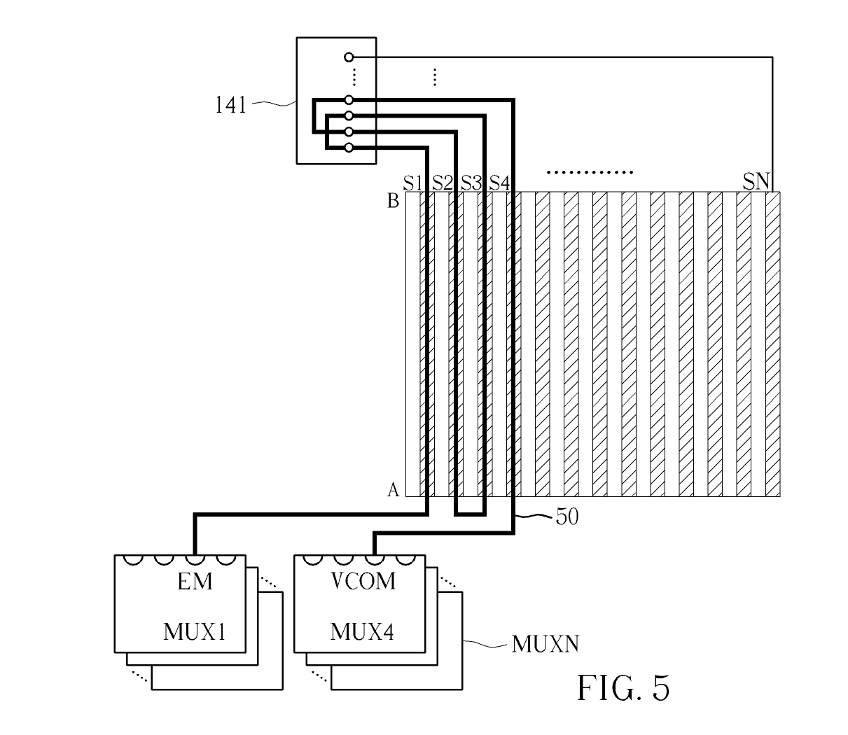

In some examples, each loop can include one or more turns. Please refer to FIG. 5, which illustrates a loop 50 formed by the multiplexers MUX (1), MUX (2), . . . , MUX(N) and the switching unit 141 through the sensing lines S1, S2, . . . , SN. The loop 50 includes two turns. In FIG. 5, the switching unit 141 conducts the terminals B of the sensing lines S1 and S3 and the terminals B of the sensing lines S2 and S4. The multiplex MUX (1) couples the terminal A of the sensing line S1 to the electromagnet terminal EM and couples the terminal A of the sensing line 2 to the terminal A of the sensing line S3. Besides, the multiplex MUX (4) couples the terminal A of the sensing line S4 to the common electrode VCOM and keeps the terminals A of the other sensing lines floating. In this situation, the touch panel 10 can use the switching unit 141 and the multiplexers MUX (1), MUX (2), . . . , MUX(N) to control the conduction among the sensing lines S1, S2, S3, . . . , SN and couple the sensing lines S1, S2, S3, . . . , SN to the different terminals, in order to form the loop 50 with 2 turns. Likewise, each loop can include one or more turns, not limited herein.

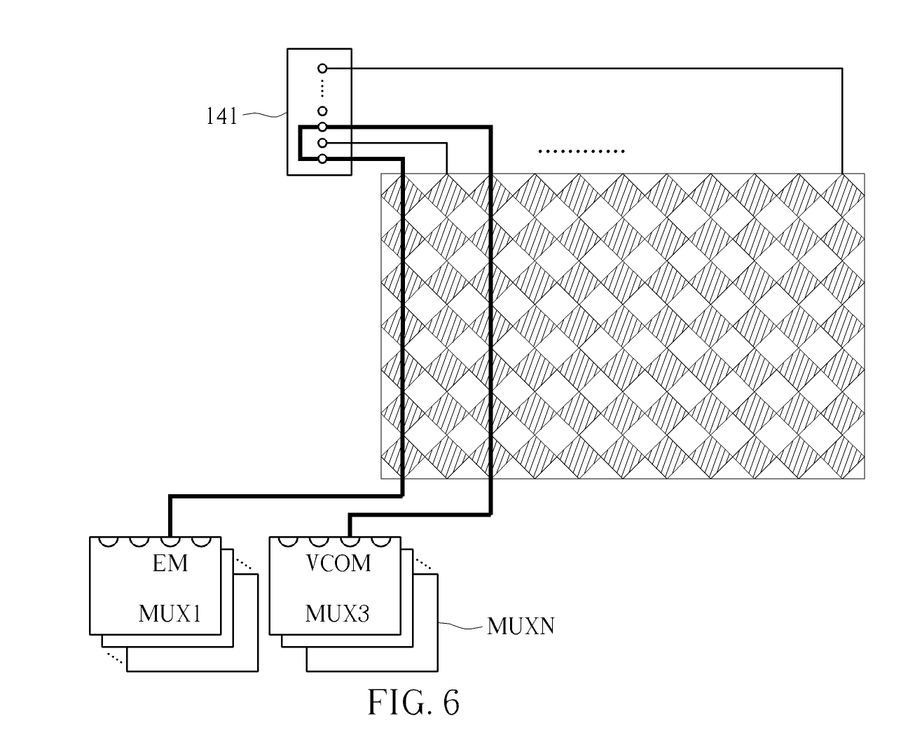

Also, the present disclosure does not specify the pattern of the sensor 100, which can be the pattern 300 in FIG. 3. Take the pattern 300 as an example, the way the switching unit 141 and the multiplexers MUX (1), MUX (2), . . . MUX (N+M) are coupled can be modified as shown in FIG. 6. The detailed operation can be found above, thus omitted herein.

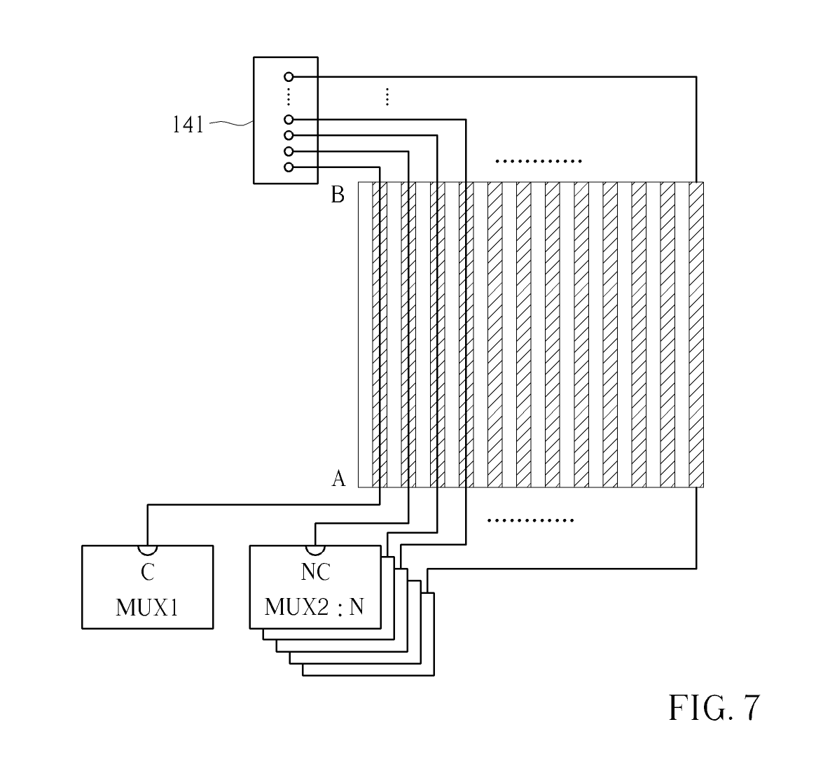

When the user generates the capacitive signal SC on the touch panel 10 (e.g. by touching the touch panel with fingers), the control circuit 140 can control the conduction among the sensing lines S1, S2, S3, . . . , SN and couple the driving lines d1, d2, d3, . . . , dN to the different terminals (e.g. the common electrode VCOM, the electromagnetic terminal EM, the capacitive terminal C, the floating terminal F or a non-sensing terminal NC), in order to sense the coordinates of the capacitive signal SC on the touch panel 10. Please refer to FIG. 7, which illustrates that the switching unit 141 and the multiplexers MUX(1), MUX(2), MUX(3), . . . , MUX(N) control the sensing lines S1, S2, S3, . . . , SN when sensing the capacitive signal SC. In FIG. 7, the switching unit 141 keeps the terminals B of the sensing lines S1, S2, S3, . . . , SN floating and the multiplexer MUX(1) couples the terminal A of the sensing line S1 to the capacitive terminal C. The capacitive terminal C is coupled to the capacitive sensing unit 180. Besides, the multiplexers MUX(2), . . . , MUX(N) couple the terminals A of the other sensing lines to the non-sensing terminal NC. The non-sensing terminal NC can generate different types of waveforms according to requirements. Preferably, the non-sensing terminal is a ground terminal or a terminal with the same phase/frequency as the capacitive terminal. In this situation, the X coordinate of the capacitive signal SC can be obtained, and the capacitive signal SC can be further received or transmitted. Likewise, the switching unit and the multiplexers MUX(N+1), MUX(N+2), . . . , MUX(N+M) can control the driving lines d1, d2, d3, . . . , dM, to obtain the Y coordinate of the capacitive signal SC on the touch panel 10.

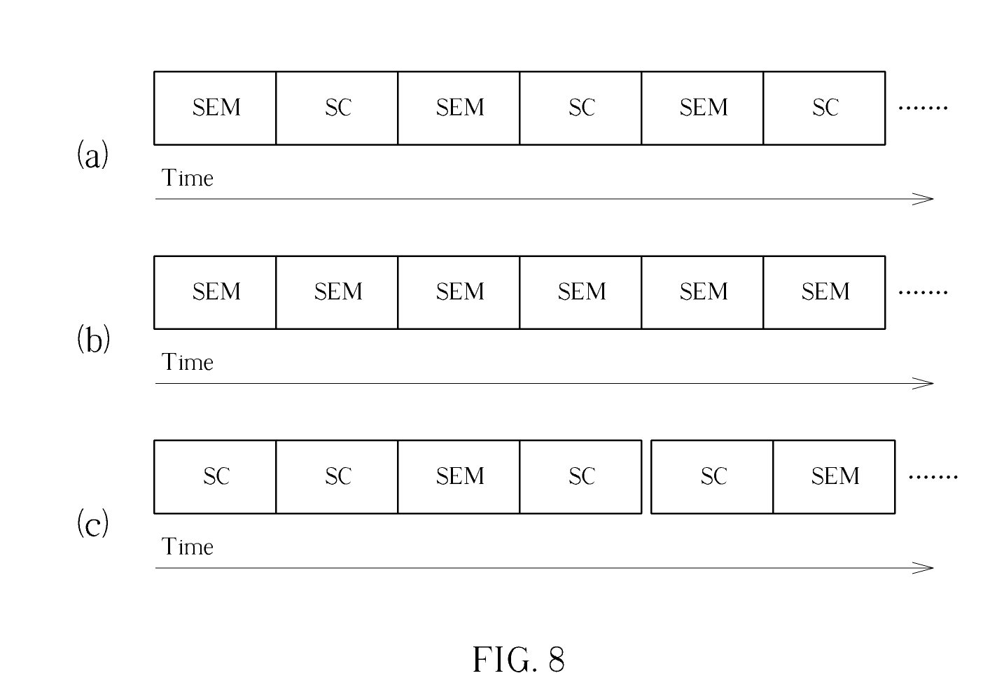

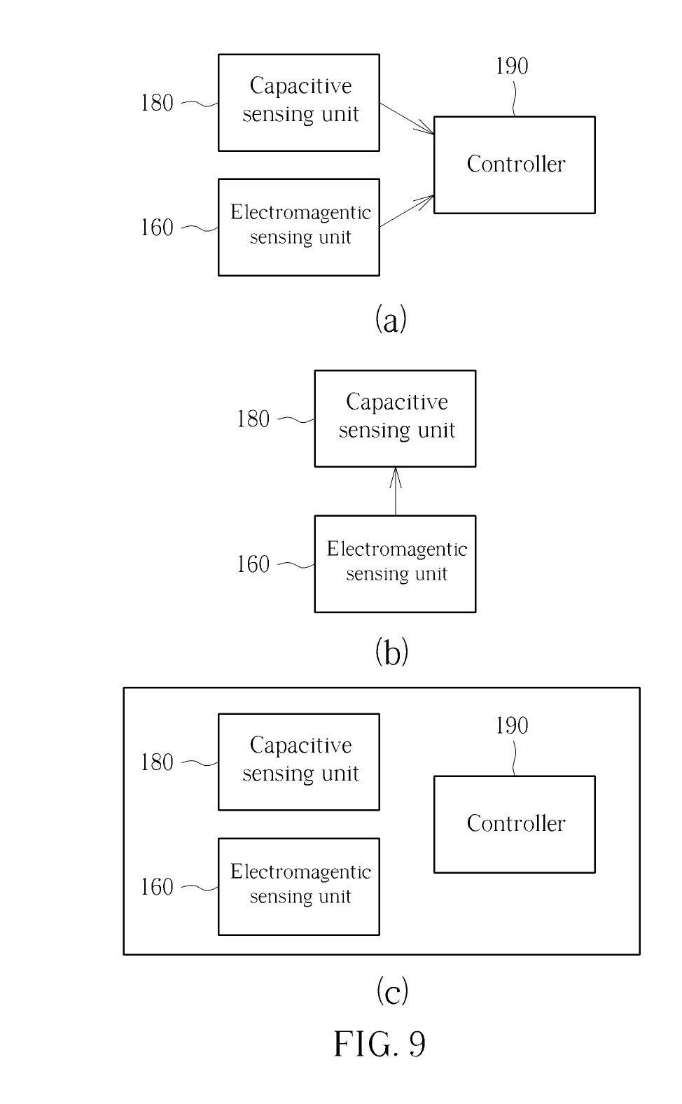

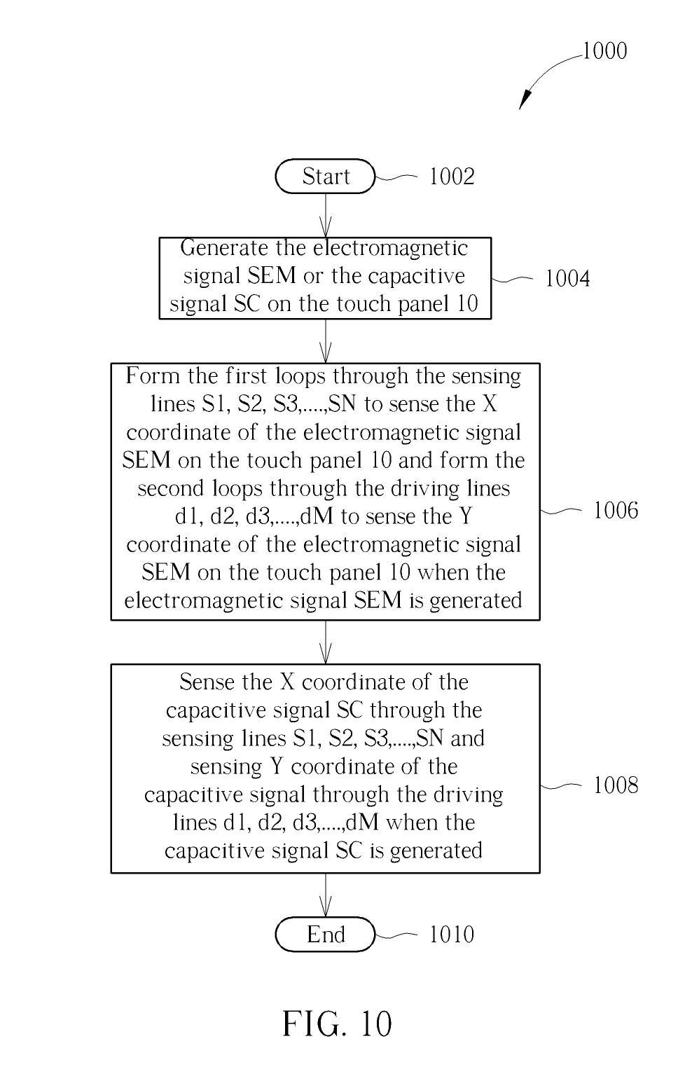

Therefore, the touch panel 10 can sense the coordinates of the electromagnet signal SEM or the capacitive signal SC on the touch panel 10 by the switching unit 141 controlling the conduction among the sensing lines and the driving lines and the multiplexers MUX(1), MUX(2), . . . MUX(N+M) coupling the sensing lines and the driving lines to the different terminals. Then, the coordinates of the electromagnet signal SEM or the capacitive signal SC are processed by the electromagnetic sensing unit 160 or the capacitive sensing unit 180, and sent out by the controller 190. The electromagnetic signal SEM and the capacitive signal SC share the same sensor 100, which can be achieved by using time-division multiplexing. Please refer to FIG. 8, which is a schematic diagram of time-division multiplexing. In FIG. 8, figure (a) shows absence of the electromagnet signal SEM and the capacitive signal SC. Figure (b) shows that the electromagnetic signal is sensed and is set in the first priority. Figure (c) shows that the capacitive signal is sensed and processed more frequently. In addition, the controller 190, the electromagnet sensing unit 160 and the capacitive sensing unit 180 can be integrated in different ways according to an example of the present disclosure. Please refer to FIG. 9, which is a schematic diagram of integration of the controller 190, the electromagnet sensing unit 160 and the capacitive sensing unit 180. In FIG. 9, figure (a) shows that the controller 190, the electromagnet sensing unit 160 and the capacitive sensing unit 180 are implemented by different chips, the controller 190 is in charge of integrating all signals at the end and sending the integrated signals to the next stage. Figure (b) shows that the electromagnet sensing unit 160 and the capacitive sensing unit 180 are implemented by the different chips, but signals are integrated in one of the chips and sent to the next stage. Figure (c) shows that the controller 190, the electromagnetic sensing unit 160 and the capacitive sensing unit 180 are integrated in a single chip. Please note that, the integration circuit 120 can also be implemented by one single chip or different chips.

The detail operation of the aforementioned touch panel 10 can be synthesized into a process 1000. The process 1000 is used for sensing the electromagnetic signal SEM and the capacitive signal SC on the touch panel 10. The process 1000 includes the following steps:

Step 1002: Start.

Step 1004: Generate the electromagnetic signal SEM or the capacitive signal SC on the touch panel 10.

Step 1006: Form the first loops through the sensing lines S1, S2, S3, . . . , SN to sense the X coordinate of the electromagnetic signal SEM on the touch panel 10 and form the second loops through the driving lines d1, d2, d3, . . . , dM to sense the Y coordinate of the electromagnetic signal SEM on the touch panel 10 when the electromagnetic signal SEM is generated.

Step 1008: Sense the X coordinate of the capacitive signal SC through the sensing lines 51, S2, 53, . . . , SN and sensing Y coordinate of the capacitive signal through the driving lines d1, d2, d3, . . . , dM when the capacitive signal SC is generated.

Step 1010: End.

The description of the process 1000 can be found above, thus omitted herein.

To sum up, when the user generates the electromagnet signal on the touch panel (e.g. with electromagnet pen), the switching unit and the multiplexers form loops through the sensing lines and driving lines, in order to sense the coordinates of the electromagnet signal. When the user generates the capacitive signal on the touch panel (e.g. with finger), the switching and the multiplexers control the conduction among the sensing lines and couple the driving lines to the different terminals (e.g. common electrode VCOM, electromagnet sensing terminal EM, capacitive sensing terminal C, floating terminal F and non-sensing terminal NC) to sense the coordinates of the capacitive signal on the touch panel. Namely, the touch panel can switch to sense the electromagnet signal or the capacitive signal by switching unit and multiplexers controlling the sensing lines and driving lines. Thus, the examples of the present disclosure can use the capacitive sensor to sense the electromagnet signal without an extra electromagnet sensor, or use the capacitive touch panel or ITO touch panel to perform electromagnet signal sensing, thereby reducing cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sensing method for a touch panel, the touch panel comprising a plurality of sensing lines and a plurality of driving lines, the method comprising:
generating an electromagnetic signal or a capacitive signal on the touch panel;
forming a plurality of first loops through the plurality of sensing lines to sense X coordinate of the electromagnetic signal on the touch panel and forming a plurality of second loops through the plurality of driving lines to sense Y coordinate of the electromagnet signal on the touch panel when the electromagnetic signal is generated; and
sensing X coordinate of the capacitive signal through the plurality of sensing lines and sensing Y coordinate of the capacitive signal through the plurality of driving lines when the capacitive signal is generated.

2. The sensing method of claim 1, wherein the step of forming each of the plurality of first loops comprises:
Conducting a first terminal of a first sensing line of the sensing lines and a first terminal of a second sensing line of the sensing lines; and
Coupling a second terminal of the first sensing line of the sensing lines to an electromagnet sensing terminal and coupling a second terminal of the second sensing line of the sensing lines to a common electrode.

3. The sensing method of claim 1, wherein step of forming each of the plurality of first loops comprises:
conducting a first terminal of a first sensing line and a first terminal of a second sensing line;
conducting a first terminal of a third sensing line and a first terminal of a forth sensing line;
coupling a second terminal of the first sensing line to an electromagnet terminal;
coupling a second terminal of the second sensing line to a second terminal of the third sensing line; and
coupling a second terminal of the forth sensing line to a common electrode.

4. The sensing method of claim 1, wherein forming each of the plurality of second loops comprises:
conducting a first terminal of a first driving line of the driving lines and a first terminal of a second driving line of the driving lines; and
coupling a second terminal of the first driving line of the driving lines to an electromagnetic sensing terminal and coupling a second terminal of the first driving line of the driving lines to a common electrode.

5. The sensing method of claim 1, wherein the step of forming each of the plurality of second loops comprises:
conducting a first terminal of a first driving line and a first terminal of a second driving line;
conducting a first terminal of a third driving line and a first terminal of a forth driving line;
coupling a second terminal of the first driving line to an electric sensing terminal;
coupling a second terminal of the second driving line to a second terminal of the third driving line; and
coupling a second terminal of the forth driving line to a common electrode.

6. The sensing method of claim 1, wherein the step of sensing the X coordinate of the capacitive signal through the plurality of sensing lines comprises:
keeping first terminals of the plurality of sensing lines floating;
coupling a second terminal of a first sensing line to a capacitance sensing terminal; and
coupling second terminals of the other sensing lines to a non-sensing terminal.

7. The sensing method of claim 1, wherein the step of sensing the Y coordinate of the capacitive signal through the plurality of driving lines comprises:
keeping first terminals of the plurality of driving lines floating;
coupling a second terminal of a first driving line to a capacitance sensing terminal; and
coupling second terminals of the other driving lines to a non-sensing terminal.

8. The sensing method of claim 1, wherein the touch panel is a capacitive touch panel or is made of Indium tin oxide (ITO) and the sensing method is a sensing method applied to the capacitive touch panel.

9. An integration circuit for a touch panel, the touch panel comprising a plurality of sensing lines and a plurality of driving lines, the integration circuit comprising:
a control circuit for controlling the plurality of sensing lines and the plurality of driving lines to sense coordinates of an electromagnetic signal or a capacitive signal on the touch panel;
a switching unit coupled to the plurality of sensing lines and the plurality of driving lines, for controlling conduction among the plurality of sensing lines and conduction among the plurality of driving lines;
a plurality of multiplexer coupled to the plurality of sensing lines and plurality of driving lines, for controlling the plurality of sensing lines and the plurality of driving lines to couple to different terminals, wherein each of the multiplexers is coupled to one of the sensing lines or one of the driving lines;
an electromagnetic sensing unit, for processing the coordinates of the electromagnetic signal on the touch panel; and
a capacitive sensing unit, for processing the coordinates of the capacitive signal on the touch panel.

10. The integration circuit of claim 9, wherein the control circuit forms a plurality of first loops through the plurality of sensing lines to sense X coordinate of the electromagnetic signal on the touch panel and forms a plurality of second loops through the plurality of driving lines to sense Y coordinate of the electromagnetic signal on the touch panel when the control circuit receives the electromagnetic signal.

11. The integration circuit of claim 10, wherein the switching unit conducts a first terminal of a first sensing line of the sensing lines and a first terminal of a second sensing line of the sensing lines, and a first multiplexer of the multiplexers couples a second terminal of the first sensing line of the sensing lines to the electromagnetic sensing unit, and a second multiplexer of the multiplexers couples a second terminal of the second sensing line of the sensing lines to a common electrode, in order to form each of the first loop.

12. The integration circuit of claim 10, wherein the switching unit conducts a first terminal of a first driving line of the driving lines and a first terminal of a second driving line of the driving lines, and a first multiplexer of the multiplexers couples a second terminal of the first driving line of the driving lines to the electromagnetic sensing unit, and a second multiplexer of the multiplexers couples a second terminal of the second driving line of the driving lines to a common electrode, in order to form each of the second loop.

13. The integration circuit of claim 10, wherein the switching unit conducts a first terminal of a first sensing line of the sensing lines and a first terminal of a second sensing line of the sensing lines, and a switching unit conducts a first terminal of a third sensing line of the sensing lines and a first terminal of a forth sensing line of the sensing lines, and a first multiplexer of the multiplexers couples a second terminal of the first sensing line of the sensing lines with the electromagnetic sensing unit, and a second multiplexer of the multiplexers couples a second terminal of the forth sensing line of the sensing lines with a common electrode, and a second terminal of the second sensing line of the sensing lines is coupled with a second terminal of the third sensing line of the sensing lines, in order to form each of the first loop.

14. The integration circuit of claim 10, wherein the switching unit conducts a first terminal of a first driving line of the driving lines and a first terminal of a second driving line of the driving lines, and a switching unit conducts a first terminal of a third driving line of the driving lines and a first terminal of a forth driving line of the driving lines, and a first multiplexer of the multiplexers couples a second terminal of the first driving line of the driving lines to the electromagnetic driving unit, and a second multiplexer of the multiplexers couples a second terminal of the forth driving line of the driving lines to a common electrode, and a second terminal of the second driving line of the driving lines is coupled to a second terminal of the third driving line of the driving lines, in order to form each of the second loop.

15. The integration circuit of claim 9, wherein the control circuit senses X coordinate of the capacitive signal through the plurality of sensing lines and senses Y coordinate of the capacitive signal through the plurality of driving lines when the control circuit receives the capacitive signal.

16. The integration circuit of claim 15, wherein the switching circuit keeps first terminals of the plurality of sensing lines floating, and a first multiplexer of the multiplexers couples a second terminal of first sensing line of the sensing line to the capacitive sensing unit, and second terminals of the other multiplexers than the first multiplexer are coupled to a non-sensing terminal, in order to sense the X coordinate of the capacitive signal on the touch panel.

17. The integration circuit of claim 15, wherein the switching unit keeps first terminals of the plurality of driving lines floating, and a first multiplexer of the multiplexers couples a second terminal of first driving line of the driving line to the capacitive sensing unit, and second terminals of the other multiplexers than the first multiplexer are coupled to a non-sensing terminal, in order to sense the Y coordinate of the capacitive signal on the touch panel.

18. The integration circuit of claim 9, wherein the touch panel is a capacitive touch panel or made of Indium tin oxide (ITO) and the integration circuit senses the electromagnetic signal through the capacitive touch panel.

19. A touch panel, comprising:
a sensor for sensing a capacitive signal or an electromagnetic signal, the sensor comprising:
a plurality of sensing lines; and
a plurality of driving lines; and
an integration circuit couple to the sensor, the integration circuit comprising:
a control circuit for controlling the plurality of sensing lines and the plurality of driving lines to sense coordinates of an electromagnetic signal or a capacitive signal on the touch panel;
a switching unit coupled to the plurality of sensing lines and the plurality of driving lines, for controlling conduction among the plurality of sensing lines and conduction among the plurality of driving lines;
a plurality of multiplexer coupled to the plurality of sensing lines and plurality of driving lines, for controlling the plurality of sensing lines and the plurality of driving lines to couple to different terminals, wherein each of the multiplexers is coupled to one of the sensing lines or one of the driving lines;
an electromagnetic sensing unit, for processing the coordinates of the electromagnetic signal on the touch panel; and
a capacitive sensing unit, for processing the coordinates of the capacitive signal on the touch panel.

20. The touch panel of claim 19, wherein the control circuit forms a plurality of first loops through the plurality of sensing lines to sense X coordinate of the electromagnetic signal on the touch panel and forms a plurality of second loops through the plurality of driving lines to sense Y coordinate of the electromagnetic signal on the touch panel when the control circuit receives the electromagnetic signal.

21. The touch panel of claim 19, wherein the switching unit conducts a first terminal of a first sensing line of the sensing lines and a first terminal of a second sensing line of the sensing lines, and a first multiplexer of the multiplexers couples a second terminal of the first sensing line of the sensing lines to the electromagnetic sensing unit, and a second multiplexer of the multiplexers couples a second terminal of the second sensing line of the sensing lines to a common electrode, in order to form each of the first loop.

22. The touch panel of claim 20, wherein the switching unit conducts a first terminal of a first driving line of the driving lines and a first terminal of a second driving line of the driving lines, and a first multiplexer of the multiplexers couples a second terminal of the first driving line of the driving lines to the electromagnetic sensing unit, and a second multiplexer of the multiplexers couples a second terminal of the second driving line of the driving lines to a common electrode, in order to form each of the second loop.

23. The touch panel of claim 20, wherein the switching unit conducts a first terminal of a first sensing line of the sensing lines and a first terminal of a second sensing line of the sensing lines, and a switching unit conducts a first terminal of a third sensing line of the sensing lines and a first terminal of a forth sensing line of the sensing lines, and a first multiplexer of the multiplexers couples a second terminal of the first sensing line of the sensing lines with the electromagnetic sensing unit, and a second multiplexer of the multiplexers couples a second terminal of the forth sensing line of the sensing lines with a common electrode, and a second terminal of the second sensing line of the sensing lines is coupled with a second terminal of the third sensing line of the sensing lines, in order to form each of the first loop.

24. The touch panel of claim 20, wherein the switching unit conducts a first terminal of a first driving line of the driving lines and a first terminal of a second driving line of the driving lines, and a switching unit conducts a first terminal of a third driving line of the driving lines and a first terminal of a forth driving line of the driving lines, and a first multiplexer of the multiplexers couples a second terminal of the first driving line of the driving lines to the electromagnetic driving unit, and a second multiplexer of the multiplexers couples a second terminal of the forth driving line of the driving lines to a common electrode, and a second terminal of the second driving line of the driving lines is coupled to a second terminal of the third driving line of the driving lines, in order to form each of the second loop.

25. The touch panel of claim 19, wherein the control circuit senses X coordinate of the capacitive signal through the plurality of sensing lines and senses Y coordinate of the capacitive signal through the plurality of driving lines when the control circuit receives the capacitive signal.

26. The touch panel of claim 25, wherein the switching circuit keeps first terminals of the plurality of sensing lines floating, and a first multiplexer of the multiplexers couples a second terminal of first sensing line of the sensing line to the capacitive sensing unit, and second terminals of the other multiplexers than the first multiplexer are coupled to a non-sensing terminal, in order to sense the X coordinate of the capacitive signal on the touch panel.

27. The touch panel of claim 25, wherein the switching unit keeps first terminals of the plurality of driving lines floating, and a first multiplexer of the multiplexers couples a second terminal of first driving line of the driving line to the capacitive sensing unit, and second terminals of the other multiplexers than the first multiplexer are coupled to a non-sensing terminal, in order to sense the Y coordinate of the capacitive signal on the touch panel.

28. The touch panel of claim 19, wherein the touch panel is a capacitive touch panel or made of Indium tin oxide (ITO) and the integration circuit senses the electromagnetic signal through the capacitive touch panel.
